(19) United States
(12) Patent Application Publication
(10) Pub. No.: US 2011/0302317 A1
(43) Pub. Date: Dec. 8, 2011

(54) MULTIMEDIA SYSTEM, MEDIA PLAYER AND METHOD FOR GENERATING PERSONALIZED STREAMING CONTENT

(75) Inventors: YEN-TING CHEN, Taipei City (TW); Hsi-Lin Kuo, Hsinchu City (TW); Yung-Tai Yang, Taipei County (TW); Din-Ji Tzou, Taipei (TW); Chih-Heng Chiu, Taipei City (TW); Chung-Won Shu, Taipei (TW)

(73) Assignee: Transcend Information , Inc., Taipei (TW)

(21) Appl. No.: 12/794,946

(22) Filed: Jun. 7, 2010

(51) Int. Cl. G06F 15/16

(52) U.S. Cl. 709/231

(57) ABSTRACT

A multimedia system, a media player, and a method for generating a personalized streaming content are provided. The method includes following steps. A play habit of a user operation is recorded into a feature log in the media player. A download request is issued to at least one server through the Internet according to the feature log and a server list. A personalized streaming content corresponding to the play habit is downloaded from the server.

### BACKGROUND OF THE INVENTION

1. Field of the Invention

The present invention generally relates to a multimedia system, and more particularly, to a multimedia system and a media player that can automatically generate a personalized streaming content.

2. Description of Related Art

Media players (for example, MP3 players and DVD players, etc) in both the software and hardware forms have been broadly used in our daily life. A user can store different digital media files in a media player to play these media files anytime. A media provider (for example, a media company or a media distributer) has to spend a lot of money to promote a new medium (for example, a song or a short video clip), so as to attract more consumers to purchase this new medium.

Along with the widespread use of the Internet, a user can search for and download his favorite media files through the Internet. For example, according to the technique disclosed in the U.S. Pat. No. US7672873, a user needs to login to a webpage on a remote server and then manually select or play desired media files from many media files. After that, the user needs to purchase/download the selected media files to a local media player.

According to the technique disclosed in the U.S. Patent No. US2010/0049862, after a user logs into an online store on a remote server, the user searches for desired media files by using keywords. The remote server analyzes the user's habit according to the keywords used by the user and accordingly provides related media files to the user. However, since in this conventional technique, the user's habit is analyzed by the remote server, the operation load of the server is considerably increased. Besides, in this conventional technique, the user needs to login to the remote server with a personal account to obtain related media files from the server.

### SUMMARY OF THE INVENTION

Accordingly, the present invention is directed to a method for generating a personalized streaming content, wherein a media player in a multimedia system automatically requests the personalized streaming content (for example, a recommended digital media) from a server according to a play habit so that a user does not need to login to the server.

According to an embodiment of the present invention, a media player including a memory module and a processing module is provided. The memory module stores a feature log. The processing module is connected to the memory module. The processing module records a play habit of a user operation into the feature log. The processing module issues a download request to at least one server through the Internet according to the feature log and a server list, so as to download at least one personalized streaming content corresponding to the play habit from the server to the memory module.

According to an embodiment of the present invention, a multimedia system including at least one server and a media player is provided. The media player is connected to the server through the Internet. The media player includes a memory module and a processing module. The memory module stores a feature log. The processing module is connected to the memory module. The processing module records a play habit of a user operation into the feature log. The processing module issues a download request to the server according to the feature log and a server list, so as to download at least one personalized streaming content corresponding to the play habit from the server to the memory module.

According to an embodiment of the present invention, a method for generating a personalized streaming content is provided. The method includes following steps. A play habit of a user operation is recorded into a feature log in the media player. A download request is issued to at least one server through the Internet according to the feature log in the media player and a server list. At least one personalized streaming content corresponding to the play habit is downloaded from the server.

In an embodiment of the present invention, when a user plays media files, a local media player analyzes and records the play habit of the user so that the operation load of a remote server can be effectively reduced. When subsequently the media player is connected to the Internet, the media player can automatically request a personalized streaming content (for example, a recommended digital media) from the server according to the play habit, so that a user does not need to login to any webpage.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a multimedia system 100 according to an embodiment of the present invention.

FIG. 2 is a flowchart of a personalized streaming content generation method according to an embodiment of the present invention.

FIGS. 3A-3B illustrate examples of the personalized streaming content generation method illustrated in FIG. 1 and FIG. 2.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention will be described below so that those having ordinary knowledge in the art can better understand and implement the present invention according to the present disclosure. However, following embodiments may also be implemented as a computer program, and the computer program can be stored in a computer-readable storage medium to allow a computer to execute the personalized streaming content generation method described below.

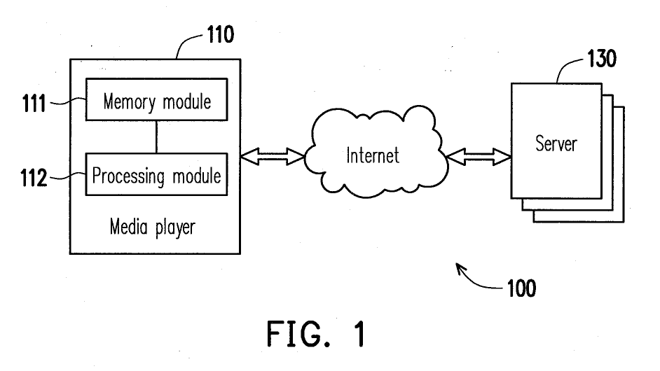

FIG. 1 is a block diagram of a multimedia system 100 according to an embodiment of the present invention. The multimedia system 100 includes a media player 110 and one or multiple servers 130. The servers 130 may be cloud servers or other types of servers. The media player 110 can be directly or indirectly connected to the servers 130 through the Internet. The media player 110 may be any software or hardware audio/video player, such as a MP3 playing device (or a MP3 playing software), a MP4 playing device (or a MP4 playing software), a DVD playing device (or a DVD playing software), a personal computer, or a handheld device, etc. In the present embodiment, the media player 110 includes a memory module 111 and a processing module 112. The processing module 112 is connected to the memory module 111. The processing module 112 may be a central processing unit (CPU) built in the media player 110 or an independent integrated circuit (IC) with calculation capability. The memory module 111 stores one or multiple media files. These media files include MP3 files, music files, animation files, movie files, and picture files but are not limited thereto. The memory module 111 also stores a feature log.

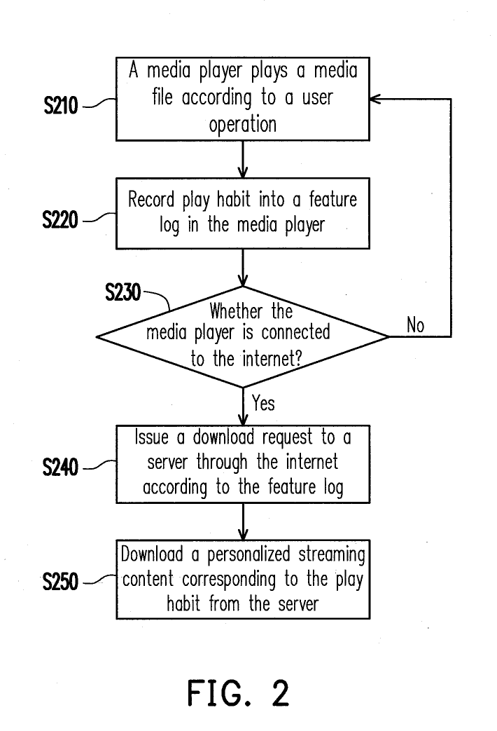

FIG. 2 is a flowchart of a personalized streaming content generation method according to an embodiment of the present invention. Referring to FIG. 1 and FIG. 2, the processing module 112 plays a media file in the memory module 111 according to a user operation (step S210) and records a play habit of the user operation into the feature log (step S220). The memory module 111 further stores a server list. The server list records the web addresses of one or multiple predetermined servers. In step S230, the processing module 112 determines whether the media player 110 is connected to the Internet. If the media player 110 is already connected to the Internet, the processing module 112 issues a download request to a server 130 according to the feature log and the server list in the memory module 111 through the Internet (step S240), so as to download one or multiple personalized streaming contents corresponding to the play habit from the server 130 (step S250), and the processing module 112 stores the personalized streaming content into the memory module 111. The personalized streaming content may be any media file corresponding to the play habit. For example, if the processing module 112 determines that songs of an artist A are played the most according to the play habit, the processing module 112 requests to download a recommended digital media related to the artist A (for example, a test audio media file or a commercial media file related to the artist A) from the server 130. Thus, when the media player 110 is connected to the Internet after the play habit is obtained, the media player 110 in the present embodiment can automatically request a personalized streaming content (for example, a recommended digital media) from the server 130 according to the play habit so that a user does not need to login to any webpage.

Foregoing step S220 can be implemented according to both the present embodiment and the actual design requirement. For example, the processing module 112 counts the number (or frequency) that a user plays each media file and records the play number corresponding to the media file into the feature log LOG in the memory module 111 as the play habit. Or, after the processing module 112 obtains the play number of each media file, it records the media file having its play number over a threshold into the feature log LOG in the memory module 111 as the play habit.

In addition, the processing module 112 may also obtain the play habit by counting the play number corresponding to the type of the media file. For example, the processing module 112 respectively counts the number each type of music (for example, classical symphony, blues, or rap, etc) is played and records the number into the feature log LOG in the memory module 111 as the play habit. Or, after the processing module 112 obtains the play number of each type of music, it records the music type having its play number over a threshold into the feature log LOG in the memory module 111 as the play habit.

Moreover, the processing module 112 may also obtain the play habit by counting the play number corresponding to the artist of the media file. For example, the processing module 112 respectively counts the play numbers corresponding to an artist A, an artist B, and an artist C and records the play number corresponding to each artist into the feature log LOG in the memory module 111 as the play habit. Or, after the processing module 112 obtains the play number corresponding to each artist, it records the artist having his corresponding play number over a threshold into the feature log LOG in the memory module 111 as the play habit.

In other embodiments, the processing module 112 can obtain the play habit by counting titles, albums, purchase records, download histories, or the records that the media files are loaded from CD or DVD into the media player 110. As described above, in the present embodiment, the local media player 110 analyzes a play habit of a user when the user plays media files and records the play habit into the feature log LOG in the memory module 111, so that the operation load of the remote servers 130 can be effectively reduced.

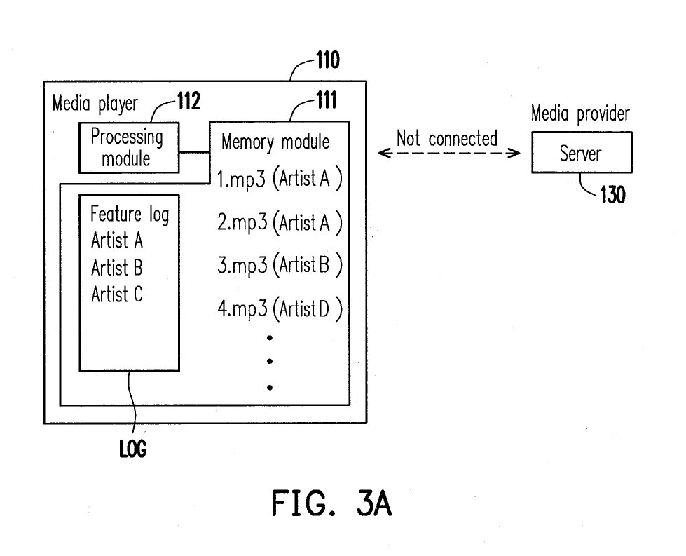

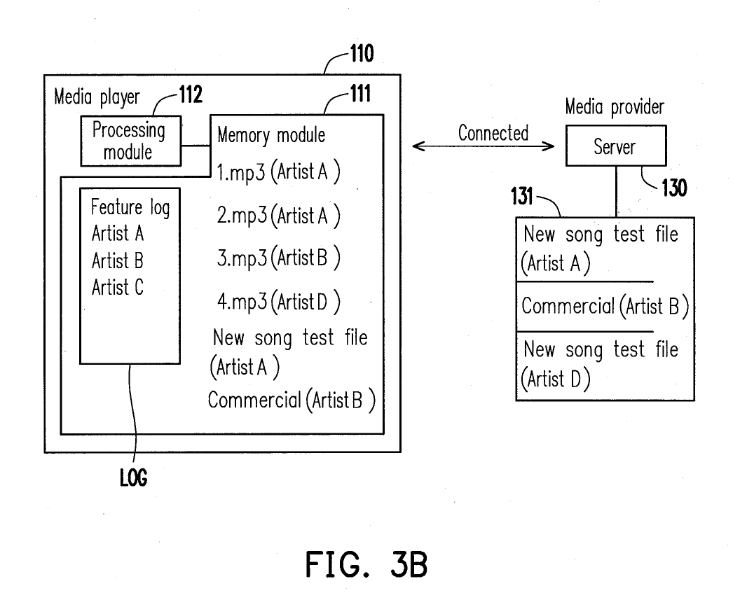

The personalized streaming content generation method illustrated in FIG. 1 and FIG. 2 will be explained with reference to the application examples illustrated in FIGS. 3A-3B. Herein it is assumed that the memory module 111 stores media files 1.mp3, 2.mp3, 3.mp3, 4.mp3, and these media files respectively have the corresponding artist information. Referring to FIG. 3A, the processing module 112 selectively plays a media file in the memory module 111 according to a user operation. During the operation of the user, the processing module 112 counts the play number corresponding to each artist and records the artist having the corresponding play number over a threshold (for example, 10 times) into the feature log LOG in the memory module 111 as the play habit. Herein it is assumed that the play habit recorded in the feature log LOG includes the artists A, B, and C.

Referring to FIG. 3B, after the media player 110 is connected to a server 130 through the Internet according to the server list, the processing module 112 issues a download request to the server 130. The download request is issued according to the feature log LOG to download streaming contents corresponding to the artists A, B, and C from the server 130. When the remote server 130 receives the download request, it searches for media files corresponding to the artists A, B, and C in a media database 131 according to the download request. Herein it is assumed that the server 130 locates a new song test file (for example, a MP3 file) of the artist A and a commercial video file (for example, a MPEG file) of the artist B in the media database 131. The server 130 converts the new song test file of the artist A and the commercial video file of the artist B into a streaming content and then downloads the streaming content to the media player 110. After the media player 110 receives the streaming content, it stores the new song test file of the artist A and the commercial video file of the artist B into the memory module 111.

Thus, a media provider (for example, a media company or a media distributer) can effectively deliver a recommended digital media to potential consumers to promote a new media (for example, a song or a short video clip) without spending a lot of money. As to a user, he or she does not need to spend any time to login to any webpage on the server 130. Namely, the user can enjoy the services provided on the website of a media provider without having to register as a member.

As described above, in an embodiment, when a user plays media files, the local media player 110 analyzes a play habit of the user and records the play habit into the memory module 111, so that the operation load of the remote servers 130 can be effectively reduced. Subsequently, when the media player 110 is connected to the Internet, the media player 110 automatically requests to download a personalized streaming content (for example, a recommended digital media) from a server 130 according to the play habit without asking a user to login to the server 130.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A media player, comprising:
a memory module, storing a feature log; and
a processing module, connected to the memory module, recording a play habit of a user operation into the feature log, and issuing a download request to at least one server through an Internet according to the feature log and a server list, so as to download at least one personalized streaming content corresponding to the play habit from the server to the memory module.

2. The media player according to claim 1, wherein the processing module obtains the play habit by counting a play number of a media file in the memory module.

3. The media player according to claim 1, wherein the processing module obtains the play habit by counting a play number corresponding to a type of a media file.

4. The media player according to claim 1, wherein the processing module obtains the play habit by counting a play number corresponding to an artist of a media file.

5. The media player according to claim 1, wherein the personalized streaming content is a test audio media file or a commercial media file corresponding to the play habit.

6. The media player according to claim 1, wherein the server list records a web address of the server.

7. A multimedia system, comprising:
at least one server; and
a media player, connected to the server through an Internet, the media player comprising:
a memory module, storing a feature log; and
a processing module, connected to the memory module, recording a play habit of a user operation into the feature log, and issuing a download request to the server according to the feature log and a server list, so as to download at least one personalized streaming content corresponding to the play habit from the server to the memory module.

8. The multimedia system according to claim 7, wherein the processing module obtains the play habit by counting a play number of a media file in the memory module.

9. The multimedia system according to claim 7, wherein the processing module obtains the play habit by counting a play number corresponding to a type of a media file.

10. The multimedia system according to claim 7, wherein the processing module obtains the play habit by counting a play number corresponding to an artist of a media file.

11. The multimedia system according to claim 7, wherein the personalized streaming content is a test audio media file or a commercial media file corresponding to the play habit.

12. The multimedia system according to claim 7, wherein the server list records a web address of the server.

13. A method for generating a personalized streaming content, comprising:
recording a play habit of a user operation into a feature log in a media player;
issuing a download request to at least one server through an Internet according to the feature log and a server list in the media player; and
downloading at least one personalized streaming content corresponding to the play habit from the server.

14. The personalized streaming content generation method according to claim 13, wherein in the step of recording the play habit into the feature log, the play habit is obtained by counting a play number of a media file in the media player.

15. The personalized streaming content generation method according to claim 13, wherein in the step of recording the play habit into the feature log, the play habit is obtained by counting a play number corresponding to a type of a media file in the media player.

16. The personalized streaming content generation method according to claim 13, wherein in the step of recording the play habit into the feature log, the play habit is obtained by counting a play number corresponding to an artist of a media file in the media player.

17. The personalized streaming content generation method according to claim 13, wherein the personalized streaming content is a test audio media file or a commercial media file corresponding to the play habit.

18. The personalized streaming content generation method according to claim 13, wherein the server list records a web address of the server.
